(19) United States
(12) Patent Application Publication
(10) Pub. No.: US 2024/0109100 A1
(43) Pub. Date: Apr. 4, 2024

(54) Asphalt Coating Compositions and Methods

(71) Applicant: Asphalt Systems, Inc., Salt Lake City, UT (US)

(72) Inventors: Joseph LaRusso, Oro Valley, AZ (US); Bradley Richard Grose, Glade Park, CO (US)

(73) Assignee: Asphalt Systems, Inc., Salt Lake City, UT (US)

(21) Appl. No.: 17/937,213

(22) Filed: Sep. 30, 2022

(51) Int. Cl. B05D 1/12; B05D 5/00; C08L 95/00

(52) U.S. Cl. CPC B05D 1/12; B05D 5/005; C08L 95/005; C08L 2555/52

(57) ABSTRACT

The present disclosure includes systems and methods for applying a coating system to a surface. An example method includes spraying an asphalt emulsion onto a surface at a rate of between about 0.12 and 0.20 gallons per square yard, the asphalt emulsion having: an asphalt blend comprising gilsonite, wherein at least a portion of the gilsonite is modified to possess a positive charge; one or more polymers, and one or more surfactants. The method may include applying a fine aggregate onto the asphalt emulsion. The fine aggregate may be applied at a rate of 2.5 pounds per square yard. In such an aspect, the asphalt emulsion may be sprayed at a rate of about 0.18 gallons per square yard, and the asphalt emulsion may contain about 56% solid asphalt residues by weight of the asphalt emulsion. In another aspect the fine aggregate may be applied at a rate of about 1.25 pounds per square yard, the asphalt emulsion may be sprayed at a rate of about 0.17 gallons per square yard, and the asphalt emulsion may contain about 37% solid asphalt residues by weight of the asphalt emulsion.

### TECHNICAL FIELD

The present disclosure relates to a coating system and related for methods for asphalt pavements.

### BACKGROUND

Asphalt pavement is a composite material that includes mineral aggregate and an asphalt binder that hardens to form a robust surface. Asphalt pavement deteriorates over time from oxidation of the asphalt binder, heavy loads, and varying climatic conditions. One method for restoring or repairing deteriorated asphalt pavement is to remove and replace the existing pavement with either newly prepared or recycled pavement. Removal and replacement, however, is expensive and wasteful. There exists, however, asphalt pavement maintenance products that are used to repair pavement surfaces.

A typical asphalt maintenance products includes a coating composition, such as a uintaite-asphalt composition, and an aggregate. In general, the composition may be spray applied to the asphalt pavement and the aggregate is then applied over the composition using spreaders or other similar devices. There are however many variations in how the composition and aggregate can be formulated. The components of the composition, type of aggregate, and the application rates (gals./yd² and/or lbs./yd²) can all be varied to accomplish certain performance objectives. Furthermore, in some cases, the coating composition and aggregates may be combined together and then applied to the pavement. In large part, however, the specific product applied to the pavement and its application rate is dependent on how the pavement is used.

The asphalt pavement industry has two somewhat separate sectors: aviation and roadway. Aviation pavements, such as those used in the construction of airport runways, have greater demands compared to roadway pavements. For aviation pavements, safety is paramount, construction operations and schedules are difficult to implement, and problems are more critical and more costly to address. Additionally, the aviation pavements are used to support airplanes whereas roadways are used for cars and trucks. The two pavements types also age differently. In general, the requirements for aviation pavements (e.g. performance requirements, specifications, quality control systems, etc.) are generally tighter and more extreme than those used for roadway pavements.

Common roadway asphalt maintenance surface treatments are not always suitable for airfield pavements. Common roadway treatments designed for durability beyond 3-5 years are typically not suitable for the required airfield pavements. As roadway treatments increase in age they also create safety-performance problems, e.g. creation and increase of foreign object debris (FOD) and decrease in positive friction characteristics. In situations where the airfield asphalt pavement, even if previously treated with a common uintaite-asphalt coating or another maintenance coating, begins to decay in terms of its surface-condition characteristics, then it must be treated again in order to maintain the minimum safety requirements. If no further treatment is applied, then the pavement must undergo a much more significant and expensive disruptive rehabilitation procedure. Common roadway treatments can be modified to improve roadway condition and increase the friction characteristics, thereby addressing the safety issues described above. Unfortunately, such treatments have a relatively brief lifespan, lasting 2-5 years or less. Other more substantial (heavily applied) asphalt maintenance treatments may provide a service-life of more than 3-5 years. However, those substantial treatments are less suitable for the requirements of airfield pavement applications. There is a lack of coating systems that can be applied at relatively heavier rates that are suitable in both roadway and aviation pavements, and have increased beneficial life.

### SUMMARY

The present disclosure includes a method for applying a coating system to a surface. In one or more aspects, the method includes spraying an asphalt emulsion onto a surface at a rate of between about 0.12 and 0.20 gallons per square yard, the asphalt emulsion having: an asphalt blend comprising gilsonite, wherein at least a portion of the gilsonite is modified to possess a positive charge; one or more polymers, and one or more surfactants. The method may include applying a fine aggregate onto the stable cationic emulsion applied to the surface. In an aspect the fine aggregate may be applied at a rate of 2.5 pounds per square yard. In such an aspect, the asphalt emulsion may be sprayed at a rate of about 0.18 gallons per square yard, and the asphalt emulsion may contain about 56% solid asphalt residues by weight of the asphalt emulsion. In another aspect the fine aggregate may be is applied at a rate of about 1.25 pounds per square yard. In such an aspect, the asphalt emulsion may be sprayed at a rate of about 0.17 gallons per square yard, and the asphalt emulsion may contain about 37% solid asphalt residues by weight of the asphalt emulsion.

In an aspect, an asphalt emulsion containing about 37% solid asphalt residues by weight of the asphalt emulsion may be sprayed at a rate of about 0.12 gallons per square yard and a fine aggregate may be applied at a rate of about 0.6 pounds per square yard. In another aspect, an asphalt emulsion containing about 37% solid asphalt residues by weight of the asphalt emulsion may be sprayed at a rate of about 0.20 gallons per square yard and the fine aggregate may be applied at a rate of about 2.0 pounds per square yard.

The present disclosure also includes a system for treating a pavement. In one aspect, a system may include an asphalt emulsion. The asphalt emulsion may include an asphalt blend comprising a first asphalt naturally containing a high amount of nitrogen-containing polar resins, wherein at least a portion of the nitrogen-containing polar resins are modified to possess a positive charge; one or more polymers; and one or more surfactants. The system may include an aggregate material for application to a pavement coated with the asphalt emulsion. The application rate of the asphalt emulsion may be between about 0.12 to about 0.20 gallons per square yard. At least a portion of the nitrogen-containing polar resins may be pyrroles. An acid modifier may be added in an amount such that the asphalt emulsion has a pH of 6.5 or less. Alternatively, an acid modifier may be added in an amount such that the asphalt emulsion has a pH of 5.0 or less. An acid modifier may include hydrochloric acid. An acid modifier may include polyphosphoric acid.

As an example, aggregate for such a system may be sized such that 98% or more of the aggregate material passes through a No. 14 sieve and 15%-45% of the aggregate material passes through a No 30 sieve. In another example, the first asphalt may be gilsonite.

In one aspect, the asphalt emulsion may contain about 56% solid asphalt residues by weight of the asphalt emulsion, may be applied to the pavement at a rate of about 0.18 gallons per square yard, and the aggregate material may be applied at a rate of about 2.5 pounds per square yard.

In another aspect, the asphalt emulsion may contain about 37% solid asphalt residues by weight of the asphalt emulsion, the asphalt emulsion may be applied to the pavement at a rate of about 0.17 gallons per square yard, and the aggregate material may be applied at a rate of about 1.25 pounds per square yard.

In another aspect, the asphalt emulsion may contain about 37% solid asphalt residues by weight of the asphalt emulsion, the asphalt emulsion may be applied to the pavement at a rate of about 0.12 gallons per square yard, and the aggregate material may be applied at a rate of about 0.6 pounds per square yard.

In another aspect, the asphalt emulsion may contain about 37% solid asphalt residues by weight of the asphalt emulsion, the asphalt emulsion may be applied to the pavement at a rate of about 0.20 gallons per square yard, and the aggregate material may be applied at a rate of about 2.0 pounds per square yard.

### BRIEF DESCRIPTION OF THE DRAWINGS

The foregoing and other features of the present disclosure will become more fully apparent from the following description, taken in conjunction with the accompanying drawings. Understanding that these drawings depict only several aspects in accordance with the disclosure and are, therefore, not to be considered limiting of its scope, the disclosure will be described with additional specificity and detail through use of the accompanying drawings. One of skill in the art may appreciate that certain features may be optional and that features or aspects of one example may be utilized or combined with other features highlighted in another example. Further, each and every aspect shown and described may not be necessary; rather, various aspects are shown and/or described as potential example features that may be included.

FIG. 1 is a graph illustrating an example graph illustrating a coefficient of friction in an area of pavement experiencing bleeding or flushing, resulting in an extremely slick and unsafe region.

FIG. 2 is a graph illustrating friction data in the wheelpath of a roadway and is provided as a control sample illustrating a typical roadway at deteriorating but “fair” condition and with typical but acceptable Friction characteristics;

FIG. 3 is a graph illustrating friction data in the wheelpath of a roadway and illustrates friction measurements of an existing coating system less than one month after application.

FIG. 4 is a graph illustrating friction data in the wheelpath of a roadway and illustrates friction measurements of an existing coating system 11 months after application.

FIG. 5 is a graph illustrating friction data in the wheelpath of a roadway and illustrates friction measurements of a coating system according to one aspect of the present disclosure 11 months after application.

FIG. 6 is a graph illustrating friction data in the wheelpath of a roadway and illustrates friction measurements of a coating system according to one aspect of the present disclosure less than one month following application.

FIG. 7 is a graph illustrating friction data in the wheelpath of a roadway and illustrates friction measurements of a coating system according to one aspect of the present disclosure 11 months following application.

### DETAILED DESCRIPTION OF ILLUSTRATIVE EMBODIMENTS

In this detailed description, reference is made to the accompanying drawings, which form a part hereof. In the drawings, similar symbols typically identify similar components, unless context dictates otherwise. The illustrative examples described in the detailed description, drawings, and potential points of novelty are not meant to be limiting. Other aspects may be utilized, and other changes may be made, without departing from the spirit or scope of the subject matter presented here. It will be readily understood that the aspects of the present disclosure, as described herein, and illustrated in the drawings, may be arranged, substituted, combined, and designed in a wide variety of different configurations, all of which are explicitly contemplated and make part of this disclosure.

In one aspect of the present disclosure, asphalt emulsion compositions for coating a paved surface are provided. In another aspect of the present disclosure, asphalt emulsion compositions and aggregates for coating a paved surface are provided. In another aspect of the present disclosure, methods of making asphalt emulsion compositions for coating a paved surface are provided. In another aspect of the present disclosure, methods of applying asphalt emulsion compositions and/or aggregate to a paved surface are provided.

Certain tests and methods of characterizing asphalt pavement, especially asphalt pavement that is aged or degraded, are known. Pavements may be graded according to the pavement condition index. Roadways and parking lots may utilize a pavement condition index according to ASTM D6433-20. Airport tarmac may utilize a pavement condition index according to ASTM D5340-20. The pavement condition index may be graded from 0-100. An index score of 85-100 may be considered good; an index score of 70-85 may be considered satisfactory; an index score of 55-70 may be considered fair; an index score of 40-55 may be considered poor. Pavement in the “poor” category is very highly undesired and may present transiting difficulties. The lower the score, the worse condition the pavement is in.

Accordingly, asphalt pavements may be characterized according to the pavement condition index. But pavements may also be characterized according to surface density, porosity, texture, water permeability, traffic volume, traffic speed, climate, weather, temperatures typically experienced, snow and ice removal processes, cleaning processes, whether the pavement has previously received a surface treatment, and the like.

The characterizations of the asphalt pavements, which may account for the physical condition of the pavement as well as typical uses of the pavement, may inform a skilled person about how to treat the pavement to make the pavement safer or generally to have more desirable characteristics. Examples of pavement treatments include fog seal treatment (applying asphalt emulsion to pavement), slurry treatment (applying asphalt emulsion that includes aggregate in slurry form), chip seal treatment (applying an asphalt emulsion and a layer of crushed rock chips sequentially), microsurfacing (similar to slurry treatment), scrub seal (a treatment similar to chip seal where the asphalt emulsion is scrubbed into distressed areas of pavement), or sequential combinations of treatments (e.g., a scrub seal followed by a slurry treatment). The various asphalt treatments may use asphalt emulsions having differing characteristics, and the selection of which treatment to use may utilizes characterizations of the asphalt pavement to be treated.

However, it has been observed that many existing treatments have certain drawbacks. For example, some treatments suffer from negative primary effects, or negative effects that are apparent in the very near-term following treatment. Negative primary effects may include improper breaking and curing, overapplication of asphalt emulsion resulting in overly slick pavement or “black ice,” and overapplication of aggregate resulting in the new treatment being scoured off quickly.

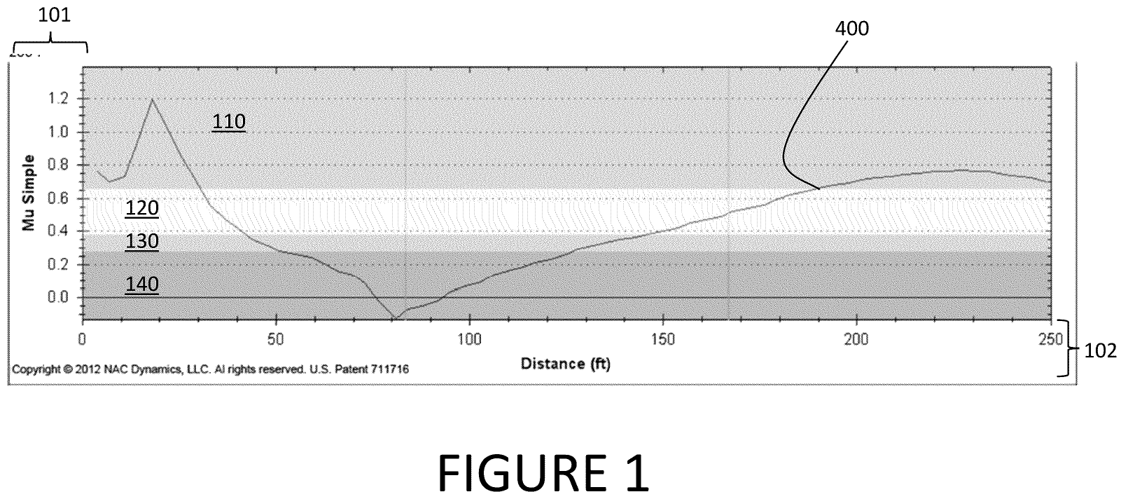

Many existing treatments may also suffer from negative secondary effects, which are negative effects that become apparent over time. Negative secondary effects may include bleeding or flushing, which results in a thin film of asphalt or oil appearing on the surface and makes the pavement overly slick; a decrease in friction over time; and densification of the pavement or even wheel-path surface rutting. The decrease in surface friction characteristics, as measured by the coefficient of friction, in a pavement area experiencing bleeding or flushing can be observed in FIG. 1. Bleeding or flushing can drastically reduce surface friction and cause unsafe areas of roadway.

In existing treatments, it may be difficult, if not impossible, to adjust certain parameters even if it is determined that pavement characteristics—or characteristics of a portion of pavement—warrant adjustment. For example, slurry and microsurfacing treatments are not able to be adjusted by the amount of aggregate after the treatment is prepared; the only adjustable factor is the application rate. Such limitations may result in a sub-optimal treatment for a pavement or a portion thereof, resulting in negative primary or negative secondary effects. Additionally, chip seals may be adjustable according to asphalt emulsion application rates and aggregate application rates but may be subject to certain minimums of each, which may also result in negative primary or negative secondary effects.

Negative primary effects and negative secondary effects are not trivial. For example, a stretch of asphalt roadway in Maine underwent a fog seal treatment. Negative primary or negative secondary effects resulted (one or more of decreased friction, bleeding, or overapplication of asphalt emulsion), the pavement post-treatment became slick, and it was determined that the slickness of the pavement caused a vehicle accident. Following that incident, Maine DOT suspended their state-wide fog seal treatment program out of safety concerns. An article from the Morning Sentinel published on Dec. 2, 2019 and titled “Maine to stop using certain road sealant on travel lanes after dangerous road conditions reported” discussed the Maine Department of Transportation decision to stop using any fog seal on roadways following a stretch of road that had been treated with a fog seal, experienced a bleeding incident resulting from the fog seal not penetrating deeply enough into the pavement that created a “glassy surface,” and caused numerous crashes.

Aspects of the present disclosure provide pavement surface treatments that reduce negative primary effects, negative secondary effects, or both. To reduce such effects, aspects of the present disclosure adjust one or more of the following: amount of solids and water in the asphalt emulsion, the application rate of the asphalt emulsion, and the application rate of aggregate. Additionally or alternatively, aspects of the present disclosure may be suitable for treating asphalt pavement that has experienced densification in certain areas of the pavement, such as the wheelpaths.

On asphalt pavements, including both airfield and roadway pavements, there is a set of pavement characteristics where existing surface treatments may result in an overapplication of asphalt emulsion or may exhibit negative primary or secondary effects similar to those resulting from overapplication. As one example, where pavement surfaces are tight (e.g., about 2 mm mean surface texture or less), density is relatively high (e.g., the wheelpaths of a roadway), and/or porosity and water permeability are relatively low, existing treatments may be precluded from penetrating sufficiently into the pavement surface. In such a case, over time and with traffic, the surface treatment itself may densify on the surface of the pavement without having penetrated into the pavement surface. In such a case, the existing surface treatment may initially improve characteristics, including friction characteristics, of the treated pavement. In an example, an improved friction characteristic includes a higher friction reading or higher coefficient of friction measurement. However, over time, the existing surface treatment may result in pavement characteristics that degrade, stabilizing in a sub-optimal pavement surface. For example, existing surface treatments may initially exhibit increased coefficient of friction readings, but those readings may decrease over time as a result of treatment densification and stabilizing in a much lower coefficient of friction. The stabilized pavement surface may thus be more slippery. In certain applications (e.g., roadways), the friction readings may be sub-optimally low. In other applications (e.g., airport tarmac), the friction readings may be impermissibly low. Even on roadways, particularly dense pavement portions treated with existing treatments may subsequently densify to an extent that the coefficient of friction becomes so low as to be unsafe.

An aspect of the present disclosure provides an asphalt-emulsion-based surface treatment that contains a higher proportion of water and/or other non-asphalt liquids than existing surface treatments. Such a treatment may exhibit significantly improved pavement characteristics on densified pavements, both immediately after treatment and in the extended time period following treatment. In one aspect, such a treatment may exhibit may provide a treated pavement that has a relatively high coefficient of friction measurement both immediately after treatment and up to at least 11 months following treatment.

In one aspect of the present disclosure, an improved asphalt emulsion is provided. In one aspect according to the present disclosure, an asphalt emulsion may include about 35% to about 50% of solid asphalt residues by weight of the emulsion. In another aspect, an asphalt emulsion may include about 37% of solid asphalt residues by weight of the emulsion. In another aspect, an asphalt emulsion may include about 1.75% of polymer (undiluted) by weight of the emulsion. In another aspect, an asphalt emulsion may include about 38.25% of solid asphalt residues by weight of the emulsion. In another aspect, an asphalt emulsion may include about 40% of solid asphalt residues by weight of the emulsion.

In an aspect, the asphalt blend prior to emulsification may comprise gilsonite. About 20% by weight of the asphalt blend may comprise gilsonite.

In one aspect of the present disclosure, an improved asphalt emulsion may be applied in a pavement surface treatment at a rate of approximately 0.12 to approximately 0.20 gallons per square yard. In another aspect of the present disclosure, an improve asphalt emulsion may be applied in a pavement surface treatment at a rate of approximately 0.15 to 0.18 gallons per square yard. In another aspect of the present disclosure, an improve asphalt emulsion may be applied in a pavement surface treatment at a rate of approximately 0.17 gallons per square yard.

In one aspect of the present disclosure, an aggregate such as a fine aggregate may be applied in a pavement surface treatment at a rate of approximately 0.6 to approximately 2.0 pounds per square yard. In another aspect of the present disclosure, an aggregate such as a fine aggregate may be applied in a pavement surface treatment at a rate of approximately 1.0 to approximately 1.5 pounds per square yard. In another aspect of the present disclosure, an aggregate such as a fine aggregate may be applied in a pavement surface treatment at a rate of approximately 1.25 pounds per square yard

In one aspect of the present disclosure, a pavement surface treatment may comprise treating the pavement by applying an asphalt emulsion evenly across a pavement surface at a rate of about 0.12 gallons per square yard and subsequently applying a fine aggregate atop the asphalt emulsion at a rate of 0.6 pounds per square yard. In one aspect of the present disclosure, a pavement surface treatment may comprise treating the pavement by applying an asphalt emulsion evenly across a pavement surface at a rate of about 0.20 gallons per square yard and subsequently applying a fine aggregate atop the asphalt emulsion at a rate of 2.0 pounds per square yard. In one aspect of the present disclosure, a pavement surface treatment may comprise treating the pavement by applying an asphalt emulsion evenly across a pavement surface at a rate of about 0.17 gallons per square yard and subsequently applying a fine aggregate atop the asphalt emulsion at a rate of 1.25 pounds per square yard.

Asphalt emulsions according to the present disclosure may include an asphalt blend that includes gilsonite. In another aspect according to the present disclosure, gilsonite in the asphalt blend in the asphalt emulsion is modified (e.g., in the presence of an acid or in a low-pH environment) to possess a positive charge. In an example, gilsonite may be retained as an asphalt (i.e., not a fraction, distillate, or derivative), and a modifier such as an acid may impart a positive charge on one or more nitrogen-containing moieties (including pyrroles). One example acid that may be used is hydrochloric acid. Another example acid that may be used is polyphosphoric acid. Gilsonite may have a relatively high amount of nitrogen-containing moieties. Gilsonite modified as such may impart a cationic effect to the asphalt emulsion without the requirement of including a cationic surfactant.

Gilsonite is a naturally occurring asphaltite hydrocarbon mineral resin. Gilsonite is a unique composition that is known to be difficult to compound into an asphalt emulsions. Gilsonite is a combination of various molecules that act in asphalt compositions in a number of different ways. Gilsonite is relatively high in polars and resins. For this reason, gilsonite can solvate asphaltenes typically present is asphalt cement. In one aspect, by driving the pH of the emulsion down to an acidic state via presence of a modifier, such as an acid, one or more nitrogen moieties (such as the pyrroles) are activated to become N+ positively charged on the surface of the gilsonite-asphalt droplet. Thus, portions of the gilsonite possess a positive or partial positive charge. This may impart the ability of the gilsonite to exhibit behaviors consistent with a cationic surfactant, yet without the requirement that a cationic surfactant per se be added to the asphalt emulsion. Additionally, the positive or partial positive charges on the gilsonite may also act as an adherent.

Asphalt may be described as a colloid system comprised various components. For example, the asphalt may include, asphaltenes, aromatics, resins, and oily/waxy saturates, among other components. In most cases, the hard asphaltenes are surrounded (solvated) by the aromatics, resins, oily/waxy saturates, and the like.

The emulsion may comprise one or more polymers. Polymers may be used to increase the durability and toughness of the completed coating system and aid in retaining fine-aggregate material in the coating applied to the pavement. Example polymers or copolymers include those that assist in providing desired properties for the asphalt emulsion residue, for example by, providing a stress-absorbing layer that strongly adheres to the underlying pavement, by providing a non-tacky surface, or by providing a polymer with a non-swelling nature. In one example, the polymers may include polymers and co-polymer combinations, such as acrylic, a styrene-butadiene rubber, or combinations thereof. The polymer or polymers may comprise between about 0.5% to about 5.0% by weight of the emulsion.

Example acrylic polymers or copolymers may include those derived from acrylate monomers. The acrylate monomers may for example be based on (meth) acrylic acid, esters of (meth) acrylic acid, (meth) acrylamide, (meth) acrylonitrile and derivatives of these acrylate monomers. Exemplary esters of (meth)acrylic acids include, but are not limited to, alkyl and hydroxyalkyl esters, e.g., methyl (meth)acrylates, ethyl (meth)acrylates, butyl (meth)acrylates, hydroxyethyl (meth)acrylate, isobornyl (meth)acrylate, and longer chain alkyl (meth)acrylates such as ethylhexyl (meth)acrylate, lauryl (meth)acrylate, cetyl (meth)acrylate, and stearyl (meth)acrylate. Derivatives of (meth)acrylamide include, but are not limited to, alkyl substituted (meth)acrylamides, e.g., N,N-dimethyl (meth)acrylamide, N,N-dipropyl (meth)acrylamide, t-butyl (meth)acrylamide, N-octyl (meth)acrylamide, and longer chain alkyl (meth)acrylamides such as N-lauryl (meth)acrylamide and N-stearyl (meth)acrylamide. The acrylic polymers also include polymers commonly known as acrylics, acrylate polymers, polyacrylates or acrylic elastomers. Acrylate polymers belong to a group of polymers which could be referred to generally as plastics while acrylic elastomer is a general term for a type of synthetic rubber whose main component is an acrylic acid alkyl ester (for example, an ethyl or butyl ester).

Example copolymers may include polymers derived from polyolefins, such as vinyl acetate, vinyl chloride, vinylidene chloride, styrene, substituted styrene, butadiene, unsaturated polyesters, ethylene and the like. In some embodiments, the acrylic copolymer is derived from acrylate monomers and mixtures thereof and polymerized with styrene or ethylene. In still other embodiments, the acrylic copolymer is derived from butyl acrylate and copolymerized with styrene or ethylene. In yet other embodiments, the copolymer is an acrylonitrile butadiene.

In one aspect, asphalt emulsions may include one or more surfactants to establish stability, viscosity and/or other properties of the emulsion during storage, transport, application, set, and cure. The surfactants may facilitate short-term and long-term enhancements of the polymer binder to in the pavement. Preferably, the surfactant is a non-cationic surfactant. [0001]

The surfactants may be a non-ionic surfactant and/or an amphoteric surfactant. In most instances, however, the emulsion does not include a cationic surfactant due to their detrimental impact on emulsion stability and reasons discussed elsewhere in the present disclosure. Accordingly, an amphoteric surfactant and/or non-ionic surfactants are preferred in lieu of cationic surfactants. Amphoteric surfactants and/or non-ionic surfactants boost the break/cure time of the emulsion when sprayed on the pavement. An amphoteric surfactant is one that can be cationic at low pH and also anionic at high pH while non-inonics do not carry specific charges. In contrast, a typical cationic surfactant, such as a fatty alkylamine, is always cationic. Cationic surfactants have a strong positive charge except at very high pH.

Example amphoteric surfactants may include alkoxylated alkylamine, betaines and imidazolinium derivatives. Example non-ionic surfactants may include ethoxylated compounds and esters, for example ethoxylated fatty alcohols, ethoxylated fatty acids, sorbitan esters, ethoxylated sorbitan esters, ethoxylated alkylphenols, ethoxylated fatty amides, glycerine fatty acid esters, alcohols, alkyl phenols, and mixtures thereof. In one example, non-ionic surfactants may include nonylphenol ethoxylate or ethoxylated alcohol.

In one aspect, one or more surfactants may constitute between about 0.25% to about 4.0% by weight of the emulsion. In one example, the surfactants comprise between 0.25% to about 2.5% by weight of the emulsion. Furthermore, the amphoteric surfactants comprise between about 0.25% to about 2.0% by weight of the emulsion. The non-cationic surfactants may comprise between about 0.25% to about 4.0% by weight of the emulsion. In one example, the non-cationic surfactants comprise between 0.375% to about 2.0% by weight of the emulsion.

In one aspect, an asphalt emulsion may include enough modifier sufficient to charge the gilsonite included in the asphalt emulsion. In one example, acid is added to the asphalt emulsion to reduce the pH below about 6.5. In another example, acid is added to the asphalt emulsion to reduce the pH below about 5.0. In one example, a modifier may be an acid present between about 0.025% to about 1.5% by weight of the emulsion. In one example, the modifier may be hydrochloric acid.

Additionally or optionally, asphalt emulsions according to the present disclosure may contain other optional additives to adjust the emulsion properties in relation to the planned use, application method, and storage conditions. These include, for example, mineral salts, thickening agents, stabilizing agents, anti-freeze agents, adhesion promoters, biocides, pigments and the like.

A pavement surface treatment according to one or more aspects of the present disclosure may include an aggregate or a fine aggregate material. The fine aggregate material may include, but is not limited to, crushed cherts, quartzites, or carbonates. Other types of fine aggregate materials may be used as well. The fine aggregate may be dry, clean, sound, durable, and angular shaped, with highly textured surfaces. The fine aggregate material may be derived from taconite ore. In one example, the fine aggregate can comprise at least 50% of silicone dioxide by weight of the fine aggregate and up to about 5% of calcium oxide by weight of the fine aggregate.

In an aspect of this disclosure, fine aggregate may be applied to a pavement surface after an asphalt emulsion. Fine aggregate may embed in and be sufficiently bound within the asphalt emulsion as the emulsion sets and cures. Fine aggregate may increase the friction characteristics of the treated pavement surface. In an embodiment, the fine aggregate can have gradation limits shown in table 1 when tested in accordance with ASTM C136. Furthermore, an exemplary fine aggregate material may include properties illustrated in table 2 further below.

TABLE 1
Fine Material Aggregate Particle Size

| | Percentage by Weight |
|---|---|
| Sieve Designation | Passing Sieves |
| 12 | 100 |
| 14 | 98-100 |
| 16 | 85-98 |
| 30 | 15-45 |
| 50 | 0-8 |
| 70 | 0-2 |
| 200 | 0-1 |

TABLE 2
Fine Aggregate Properties

| Test | Test Method | Range |
|---|---|---|
| Micro-Deval | ASTM D7428 | Up to 15% |
| Magnesium | ASTM C88- Fine | Up to 2% |
| Sulfate Soundness | Aggregate | |
| LA Abrasion | ASTIM C131 - | Up to 8% |
| | Grading D | |
| Fine Aggregate | ASTM C1252 - | At least 45% |
| Angularity | Test Method A | |
| Moisture Content (%) | ASTM C566 | Up to 2% |
| Bulk Dry Specific Gravity | ASTM C128 | 2.6-3.0 |
| Bulk SSD Specific Gravity | ASTM C128 | 2.6-3.0 |
| Apparent Specific Gravity | ASTM C128 | 2.6-3.2 |
| Absorption (%) | ASTM D2216 | Up to 3% |
| Mohs Hardness | Mohs Scale | At least 7.0 |
| AIMS texture | AIMS Texture Index | At least 90% |
| Polished Stone Value | ASTM 3319 | At least 65 |

An aspect of the present disclosure includes a method of making an asphalt emulsion. Initially, the method may include blending asphalt cement with gilsonite. The blending may be performed using a standard vat mixer or the like. This blending step may include adding an optional gas oil, e.g. an atmospheric light oil, to the asphalt blend. The gas oil may assist the penetration of the emulsion into the underlying pavement. Next, an optional chemical may be added to the asphalt blend. This optional chemical may be used to assist melting and blending of gilsonite in the asphalt blend. The asphalt blend composition may be exposed to temperature of at least about 300 degrees Fahrenheit for a period of time. In one example, the asphalt blend may be exposed to a temperature of about 350 degrees Fahrenheit and mixed, at the elevated temperature, for 24-48 hours. In another example, the asphalt blend may be exposed to a temperature of about 400 degrees Fahrenheit and mixed, at the elevated temperature, for about 24 hours.

A method may include preparing an aqueous solution comprising water, a modifier (e.g., acid), one or more surfactants, and/or one or more other additives. In one example, acid may be added to water or a solution of water and surfactant(s), which may be mixed. In one aspect, a method may include pumping the asphalt blend and the aqueous solution into an emulsion mill to form an asphalt emulsion. In one aspect, one or more polymers may be added to the aqueous solution or to the asphalt emulsion.

In one aspect, a method may include adding a modifier, such as hydrochloric acid, to water, along with one or more surfactants and/or other additives to form an aqueous solution, which may then be added to an asphalt blend to emulsify the asphalt therein.

In another aspect, a method may include adding a modifier, such as polyphosphoric acid, to the asphalt blend. In this aspect, the polyphosphoric acid may be added to the asphalt blend, where it may modify the gilsonite therein to impart a positive charge or partial positive charge on nitrogen-containing moieties such as pyrroles. An aqueous solution (where the aqueous solution is not acidic) may then be combined with the asphalt blend. The modified gilsonite may have surfactant-like qualities, which may reduce if not eliminate the need to add a separate surfactant.

In one aspect according to the present disclosure, an asphalt emulsion according to the present disclosure was applied to densified pavement wheelpaths. The asphalt emulsion contained about 56% of solid asphalt residues. A no-treatment control was measured for friction characteristics, as were pavement wheelpaths where the asphalt emulsion was applied at a rate of 0.22 gallons per square yard and fine aggregate was applied at a rate of about 2.5 pounds per square yard, consistent with existing pavement treatments. The existing pavement treatment was also modified to include the same asphalt emulsion (containing about 56% of solid asphalt residues) but at a lower rate of about 0.18 gallons per square yard and fine aggregate applied at a rate of about 2.5 pounds per square yard. Thus, the modified treatment applied less asphalt emulsion to the densified pavement wheelpaths. The data in Table 3 were obtained:

TABLE 3
Asphalt Emulsion Containing About 56% Solid Asphalt Residues
at Existing Treatment Rates and Modified Treatment Rates

| | | Coefficient | Coefficient |
|---|---|---|---|
| Asphalt Emulsion | | of friction | of friction |
| Treatment | Status | at 40 mph | at 60 mph |
| Pre-treatment Control | No treatment | 0.49 | 0.39 |
| 0.22 gals/SY | <1 month | 0.92 | 0.82 |
| 0.22 gals/SY | 11 months | 0.64 | 0.35 |
| 0.22 gals/SY | 36 months | 0.47 | 0.39 |
| 0.18 gals/SY | 11 months | 0.73 | 0.53 |
| 0.18 gals/SY | 36 months | 0.51 | 0.43 |

In another aspect according to the present disclosure, an asphalt emulsion according to the present disclosure was applied to densified pavement wheelpaths. The asphalt emulsion contained about 37% of solid asphalt residues, with a corresponding increase of water in the emulsion. The more dilute asphalt emulsion was applied to the densified wheelpaths at a rate of about 0.17 gallons per square yard. A fine aggregate was applied following the application of the asphalt emulsion at a rate of about 1.25 pounds per square yard. Thus, the modified treatment applied a lesser amount of a more dilute asphalt emulsion to the densified pavement wheelpaths and was followed by a lighter application of fine aggregate compared to existing pavement treatments. The following data in Table 4 were obtained:

TABLE 4
Asphalt Emulsion Containing About 37% Solid
Asphalt Residues at Lower Treatment Rates

| | | Coefficient | Coefficient |
|---|---|---|---|
| Asphalt Emulsion | | of friction | of friction |
| Treatment | Status | at 40 mph | at 60 mph |
| 0.17 gals/SY of a more | <1 month | 0.92 | 0.76 |
| dilute emulsion | | | |
| 0.17 gals/SY of a more | 11 months | 0.65 | 0.65 |
| dilute emulsion | | | |

Data obtained from the tests were graphed, and the graphs are included in the drawings. The graphs reflect coefficient of friction measurements taken at 60 mph.

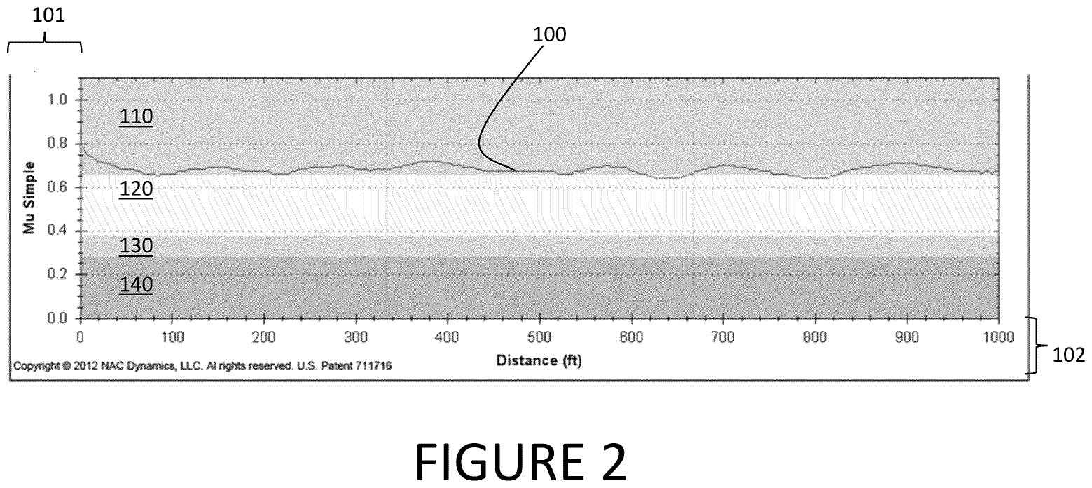

FIG. 2 is a graph illustrating friction data in the wheelpath of a roadway and is provided as a control sample illustrating a typical roadway at deteriorating but “fair” condition and with typical but acceptable Friction characteristics. The graph includes the coefficient of friction, mu, on the y-axis 101. The graph includes the distance traveled on the sampled pavement on the x-axis 102. The background of the graph includes a region 110 indicating pavement surface condition, in regards to friction characteristics, as “excellent” or “good”; a region 120 indicating it as “good” or “fair”; a region 130 indicating it as “poor” and “unsafe for airfield tarmac”; and a region 140 indicating a pavement quality as “unsafe for roadways.” The y-axis 101, x-axis 102, and regions 110, 120, 130, and 140 are the same across the graphs of each Figure. Regardless of the foregoing outline of regions 110, 120, 130, 140, a coefficient of friction (mu) between 0.72 to 1.00 is considered excellent, a mu between 0.52 to 0.71 is considered good, a mu between 0.42 to 0.51 is considered fair, a mu between 0.30 to 0.41 is considered poor and unsafe for airfield tarmac, and a mu less than 0.30 is considered unsafe for roadways. Despite the foregoing divisions and labeling of regions 110, 120, 130, 140, a higher mu generally represents more favorable surface friction characteristics than a lower mu. At very low mu levels, the pavement surface may be so slick as to be unsafe. Accordingly, a mu of 0.60 may be more advantageous than a mu of 0.45, even though the mu of 0.45 would not technically place the surface at an “unsafe” level.

The control sample without any surface treatment of FIG. 2 shows a measured coefficient of friction 100 of the pavement surface holding relatively steady along a “good” region 110.

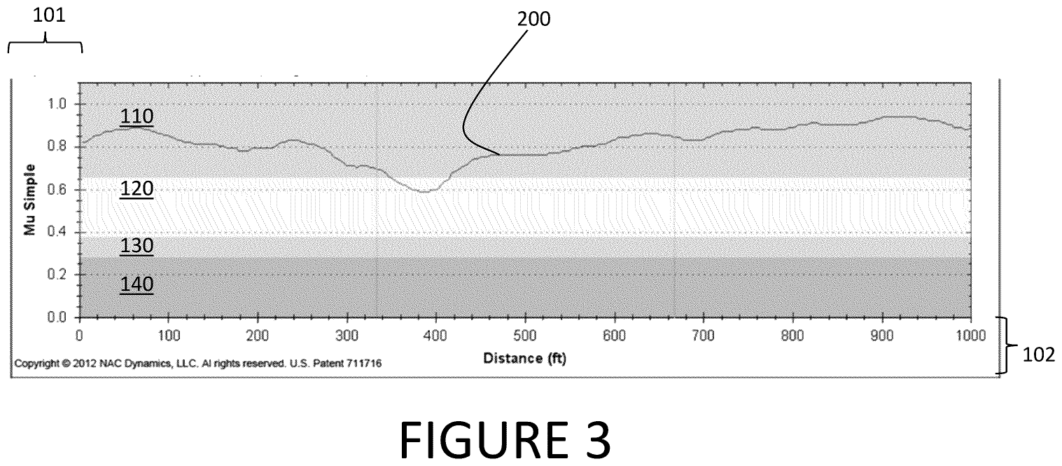

FIG. 3 is a graph illustrating friction data in the wheelpath of a roadway and illustrates friction measurements of an existing coating system less than one month after application. The pavement in FIG. 2 underwent an existing surface treatment with an applied asphalt emulsion having about 56% solid asphalt residues applied at a rate of about 0.22 gallons per square yard and applied fine aggregate at a rate of 2.5 pounds per square yard. Less than one month after surface treatment, measured coefficient of friction 200 shows general initial improvement in friction characteristics compared to the control, with a portion between 350 and 400 meters showing possible initial densification, which could signify future negative secondary effects.

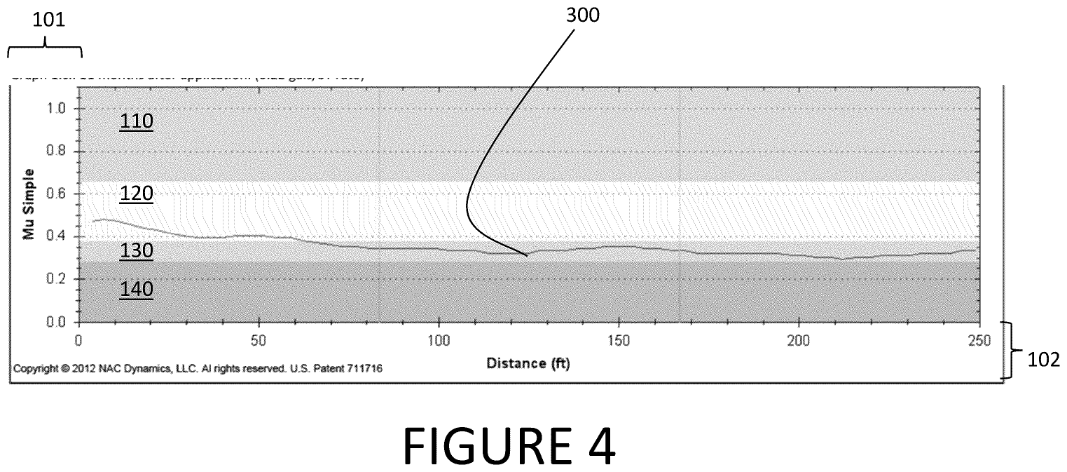

FIG. 4 is a graph illustrating friction data in the wheelpath of a roadway and illustrates friction measurements of an existing coating system 11 months after application. The pavement in FIG. 3 underwent an existing surface treatment with an applied asphalt emulsion having about 56% solid asphalt residues applied at a rate of about 0.22 gallons per square yard and applied fine aggregate at a rate of 2.5 pounds per square yard. 11 months after surface treatment, measured coefficient of friction 300 shows significant deterioration of friction characteristics across the pavement, falling generally to the “poor” and “unsafe for airfield tarmac” region 130. This could reflect a negative secondary effect of surface treatment densification across the pavement.

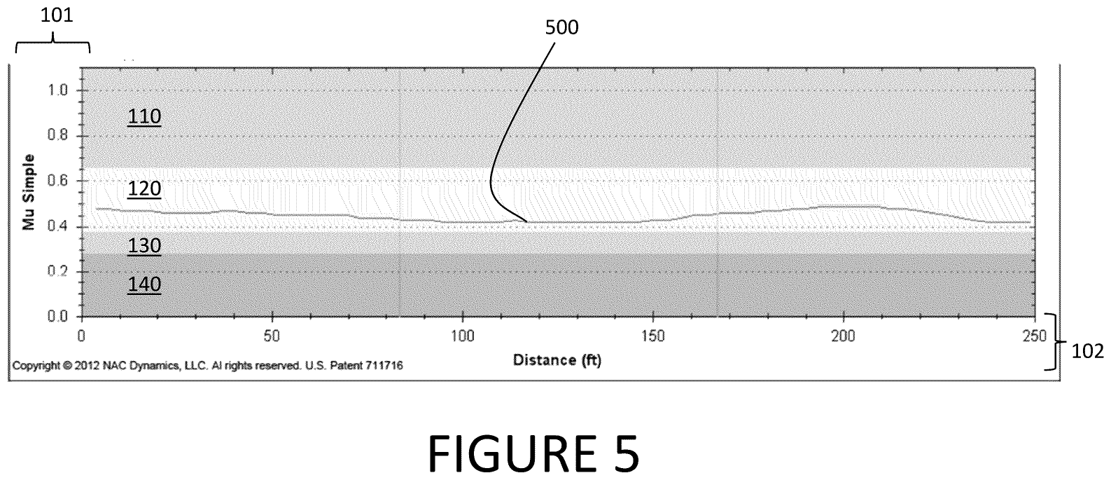

FIG. 5 is a graph illustrating friction data in the wheelpath of a roadway and illustrates friction measurements of a coating system according to one aspect of the present disclosure 11 months after application. The pavement in FIG. 5 underwent a surface treatment in accordance with one aspect of the present disclosure with an applied asphalt emulsion having about 56% solid asphalt residues applied at a reduced rate of about 0.18 gallons per square yard and applied fine aggregate at a rate of 2.5 pounds per square yard. Nearly a year following the surface treatment, the measured coefficient of friction 500 is both uniform and within the acceptable “good” or “fair” region 120, with a mu averaging just below about 0.50. Compared to existing surface treatments, the modified treatment graphed in FIG. 5 shows improved friction characteristics without significant localized reductions in coefficient of friction, which may present as unsafe slick spots on pavement.

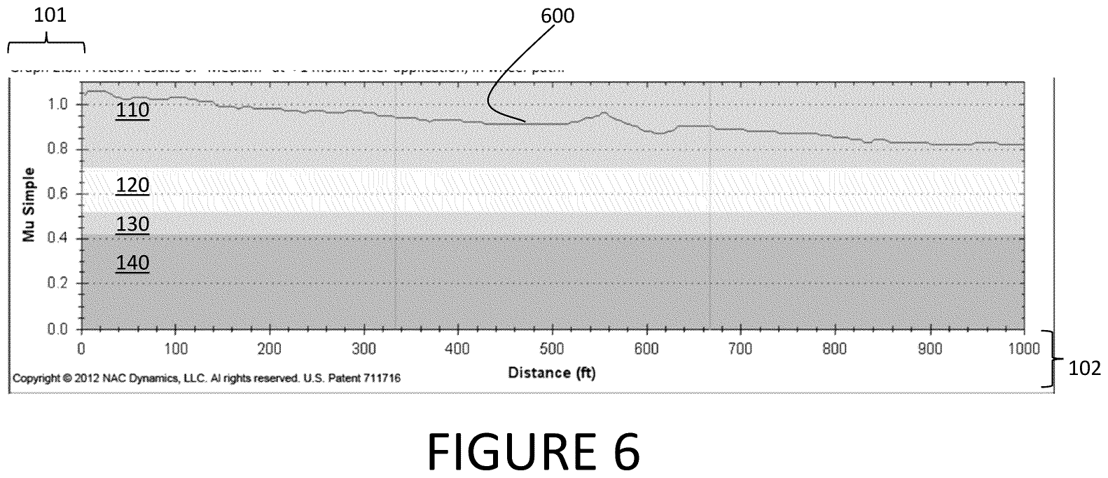

FIG. 6 is a graph illustrating friction data in the wheelpath of a roadway and illustrates friction measurements of a coating system according to one aspect of the present disclosure less than one month following application. The pavement in FIG. 6 underwent a surface treatment in accordance with another aspect of the present disclosure with an applied asphalt emulsion having about 37% solid asphalt residues applied at a rate of about 0.17 gallons per square yard and applied fine aggregate at a rate of 1.25 pounds per square yard. Less than one month following surface treatment, the measured coefficient of friction 600 is very uniform across the whole pavement and has highly significantly improved friction characteristics.

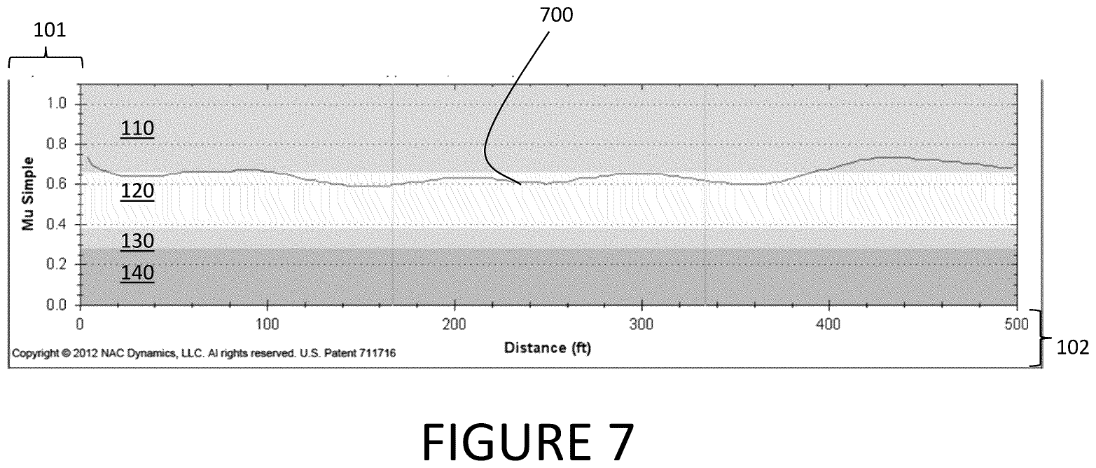

FIG. 7 is a graph illustrating friction data in the wheelpath of a roadway and illustrates friction measurements of a coating system according to one aspect of the present disclosure 11 months following application. The pavement in FIG. 6 underwent a surface treatment in accordance with another aspect of the present disclosure with an applied asphalt emulsion having about 37% solid asphalt residues applied at a rate of about 0.17 gallons per square yard and applied fine aggregate at a rate of 1.25 pounds per square yard. Nearly a year following the surface treatment, the measured coefficient of friction 700 remains highly uniform across the whole pavement and retains highly improved friction characteristics reflecting “excellent” or “good” friction characteristics.

Accordingly, to varying degrees, the surface treatments according to aspects of the present disclosure present improved friction characteristics of the pavements, some of which are long lasting and which significantly reduce the incidence of negative secondary effects prevalent on the existing surface treatments that likely result from surface treatment densification.

While various aspects have been disclosed herein, other aspects will be apparent to those skilled in the art. The various aspects disclosed herein are for purposes of illustration and are not intended to be limiting, with the true scope and spirit being indicated by the claims.

What is claimed is:

1. A method for applying a coating system to a surface, comprising:
spraying an asphalt emulsion onto a surface at a rate of between about 0.12 and 0.20 gallons per square yard, the asphalt emulsion having:
a) an asphalt blend comprising gilsonite, wherein at least a portion of the gilsonite is modified to possess a positive charge;
b) one or more polymers, and
c) one or more surfactants; and
applying a fine aggregate onto the asphalt emulsion applied to the surface.

2. The method of claim 1, wherein the fine aggregate is applied at a rate of about 2.5 pounds per square yard.

3. The method of claim 1, wherein the fine aggregate is applied at a rate of about 1.25 pounds per square yard.

4. The method of claim 2, wherein the asphalt emulsion is sprayed at a rate of about 0.18 gallons per square yard.

5. The method of claim 3, wherein the asphalt emulsion is sprayed at about a rate of 0.17 gallons per square yard.

6. The method of claim 1, wherein applying the fine aggregate and spraying the asphalt emulsion are performed with the same applicator vehicle.

7. The method of claim 1, wherein the asphalt emulsion contains about 56% solid asphalt residues by weight of the asphalt emulsion.

8. The method of claim 1, wherein the asphalt emulsion contains about 37% solid asphalt residues by weight of the asphalt emulsion.

9. The method of claim 2, wherein the asphalt emulsion contains about 56% solid asphalt residues by weight of the asphalt emulsion.

10. The method of claim 3, wherein the asphalt emulsion contains about 37% solid asphalt residues by weight of the asphalt emulsion.

11. The method of claim 4, wherein the asphalt emulsion contains about 56% solid asphalt residues by weight of the asphalt emulsion.

12. The method of claim 5, wherein the asphalt emulsion contains about 37% solid asphalt residues by weight of the asphalt emulsion.

13. The method of claim 1, wherein the asphalt emulsion is sprayed at a rate of about 0.12 gallons per square yard and the fine aggregate is applied at a rate of about 0.6 pounds per square yard.

14. The method of claim 1, wherein the asphalt emulsion is sprayed at a rate of about 0.20 gallons per square yard and the fine aggregate is applied at a rate of about 2.0 pounds per square yard.

15. The method of claim 13, wherein the asphalt emulsion contains about 37% solid asphalt residues by weight of the asphalt emulsion.

16. The method of claim 14, wherein the asphalt emulsion contains about 37% solid asphalt residues by weight of the asphalt emulsion.

17. A system for surface treating a pavement, comprising:
an asphalt emulsion, the asphalt emulsion including:
an asphalt blend comprising a first asphalt naturally containing a high amount of nitrogen-containing polar resins, wherein at least a portion of the nitrogen-containing polar resins are modified to possess a positive charge;
one or more polymers; and
one or more surfactants; and
an aggregate material for application to a pavement coated with the asphalt emulsion;
wherein the asphalt emulsion is applied to the pavement at a rate of between about 0.12 to about 0.20 gallons per square yard.

18. The system of claim 17, wherein at least a portion of the nitrogen-containing polar resins are pyrroles.

19. The system of claim 17, further comprising an acid modifier in an amount such that the asphalt emulsion has a pH of 6.5 or less.

20. The system of claim 17, further comprising an acid modifier in an amount such that the asphalt emulsion has a pH of 5.0 or less.

21. The system of claim 13, wherein 98% or more of the aggregate material passes through a No. 14 sieve and 15%-45% of the aggregate material passes through a No 30 sieve.

22. The system of claim 13, wherein the first asphalt is gilsonite.

23. The system of claim 13, wherein the asphalt emulsion contains about 56% solid asphalt residues by weight of the asphalt emulsion, wherein the asphalt emulsion is applied to the pavement at a rate of about 0.18 gallons per square yard, and wherein the aggregate material is applied at a rate of about 2.5 pounds per square yard.

24. The system of claim 13, wherein the asphalt emulsion contains about 37% solid asphalt residues by weight of the asphalt emulsion, wherein the asphalt emulsion is applied to the pavement at a rate of about 0.17 gallons per square yard, and wherein the aggregate material is applied at a rate of about 1.25 pounds per square yard.

25. The system of claim 13, wherein the asphalt emulsion contains about 37% solid asphalt residues by weight of the asphalt emulsion, wherein the asphalt emulsion is applied to the pavement at a rate of about 0.12 gallons per square yard, and wherein the aggregate material is applied at a rate of about 0.6 pounds per square yard.

26. The system of claim 13, wherein the asphalt emulsion contains about 37% solid asphalt residues by weight of the asphalt emulsion, wherein the asphalt emulsion is applied to the pavement at a rate of about 0.20 gallons per square yard, and wherein the aggregate material is applied at a rate of about 2.0 pounds per square yard.
